(19) United States
(12) Patent Application Publication
(10) Pub. No.: US 2013/0240270 A1
(43) Pub. Date: Sep. 19, 2013

(54) METHOD AND APPARATUS FOR PROCESSING SENSOR INPUTS

(71) Applicants: Anthony Bryan Pleasants, Hamilton (NZ); Simon James Lovatt, Hamilton (NZ)

(72) Inventors: Anthony Bryan Pleasants, Hamilton (NZ); Simon James Lovatt, Hamilton (NZ)

(73) Assignee: AgResearch Limited, Hamilton (NZ)

(21) Appl. No.: 13/821,439

(22) PCT Filed: Sep. 7, 2011
(86) PCT No.: PCT/NZ2011/000183

§ 371 Date: May 24, 2013

(30) Foreign Application Priority Data
Sep. 9, 2010 (NZ) 585886

(51) Int. Cl. G01G 17/08

(52) U.S. Cl. CPC G01G 17/08
USPC 177/1; 177/25.11

(57) ABSTRACT

A method of determining the weight distribution of a population is provided, including the steps of
a) determining a likely weight range for members within the population;
b) enabling a plurality of members of the population to impact on a weighing device wherein multiple members may be on the weighing device at one time;
c) recording inputs from the weighing device wherein each input corresponds to the presence of the multiple members on the weighing device at one time; and
d) using values derived from the inputs and applying an algorithm to specify a number of subsets, each of the subsets representing a discrete number or proportion of members with weight values associated with same.

### TECHNICAL FIELD

This invention relates to a method and apparatus for processing sensor inputs.

In particular, the present invention relates to sensor inputs from weighing devices.

### BACKGROUND ART

There are many situations whereby it is desirable to know the weight distribution of a bulk population.

Possible uses for this information as applied to various applications include:
Knowing when to harvest a whole chicken population.
Currently a whole population of chickens is slaughtered when it is estimated that the growing chickens have reached a specified target weight or are consuming too much feed for their output (e.g. their rate of weight gain). Understandably, making a decision to slaughter a whole population based on an estimate can lead to significant losses through either slaughtering the population before they reached maximum growth efficiency, or slaughtering the population after their growth efficiency has significantly dropped from the maximum.
Knowing when it is necessary to weigh individual beef cattle to decide when to send appropriately sized beasts to the abattoir.
Determining from which farms to source sheep/lambs so as to optimise contracts with further processors and retailers.
Optimising packhouse configuration for variable size produce weighed at harvest—such as squash.
Sorting herds or flocks into high and low growth rates based on a changing population distribution over time

Current weighing systems are not set up to efficiently provide data from which good decisions can be made with regard to the above and other applications, since they require each and every animal to weighed individually and sequentially.

In the dairy industry, weigh scales are provided in a controlled environment (such as a race) to give individual animal weights which are then recorded in a database against each animal's identification (ID) code. This process works well for cows and dairy farmers as the animals travel at least once daily through races to a milking shed.

Controlling the population is essential for this situation, otherwise there are problems such as:
multiple or partial animals standing on the platform
random movement of animals
difficulties in reading radio frequency identity (RFID) tags when animals are in close proximity to each other.

However, this system is not suitable for bulk populations existing in a less controlled environment such as sheep, beef cattle, chickens and harvested produce.

The time taken to use the technology developed for dairy animals to individually weigh each member of a bulk population would be problematic. Existing weigh scale technology relies on time for the weigh scale to settle before it takes a reading. Obliviously this would not be suitable for populations of (say) chickens even if they could be readily singulated before being weighed.

It should also be noted that with equipment designed to weigh individuals, there can still be considerable error. This can be due to a number of factors.

One of these factors is the movement of the animal on the weigh scale.

Another factor is the tolerances or limits of the technology.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

DISCLOSURE OF THE INVENTION

According to one aspect of the present invention there is provided a method of determining the weight distribution of a population

the method characterised by the steps of
a) determining a likely weight range for members within the population
b) enabling a plurality of members of the population to impact on a weighing device wherein multiple members may be on the weighing device at one time,
c) recording inputs from the weighing device wherein each input corresponds to the presence of the multiple members on the weighing device at one time,
d) using values derived from the inputs and applying an algorithm to specify a number of subsets, each of the subsets representing a discrete number or proportion of members with weight values associated with same.

In preferred embodiments of the present invention, the subsets are used to determine a weight frequency distribution for the measured population.

According to another aspect of the present invention there is provided a method of obtaining a value from a weighing device for use in the above method characterised by the step of
processing the inputs from the weighing device to provide an indicative value of sample size and weight.

According to yet another aspect of the present invention there is provided a weighing device for use in the methods described above, the weighing device characterised in that it includes
a platform of sufficient size to receive a plurality of members of a population to be weighed,
the platform having at least one ingress and egress for the members, and
a weigh sensor for receiving inputs from members of the population positioned on the platform, and
a processor programmed to process the inputs into values suitable for the calculation of the weight distribution of the population.

According to a further aspect of the present invention there is provided a weighing system having at least one weighing device as identified previously and an animal guidance system.

The term animal guidance system is intended to be any means by which the animals can be guided onto or off the weighing device.

For example, in some embodiments the animal guidance system may be a race typically used in relation to animals such a sheep and cattle. However other animal guidance systems may be used, such as a combination of tunnels, corridors and gates depending on the situation.

According to yet another aspect of the present invention there is provided a computer program configured to be executable by a processor to perform a method for determining the weight distribution of a population as described above.

For ease of reference, the specification will now refer to the population as being herd animals. However, this should not be seen as limiting.

It should be appreciated that the present invention can apply to various populations including herd/flock animals such as beef, sheep and chickens as well as in some instances produce such as squash.

It is envisaged that the determination of the likely weight range for the population will be sufficiently broad so as to encompass all members of that population, but sufficiently narrow so as to eliminate the possibility of double readings. For example, it is envisaged that typical weight ranges would take into account population variance.

It is envisaged that with herd animals such as sheep and cattle the animals would be driven through an animal guidance system such as a race of some type in order to compel the animals to run over a weighing device. Care needs to be taken to ensure that the rate at which the animals run over the weighing device is not so slow as to be inefficient, nor so fast so as not to be able to obtain readings from the weighing device to give sufficiently accurate values.

Thus, care needs to be taken in terms of the size of the surface area of the platform as that represents the maximum number of animals that can be read at any one time.

In some embodiments of the present invention there may be provided a control mechanism which keeps the number of animals on the weighing device constant. That is in one embodiment of the present invention only the same number of animals may be allowed onto and off the device at any one time.

For example, there may be allowed one animal off and one animal onto the weighing device at one time, but with two or more animals being present on the weighing device when recording a weight reading. This can enable the actual weight of an individual animal to be recorded (particularly if they had identification). The inventors have found that weigh scale error is driven down as a consequence of this method as effectively there is provided more measurements (say from the bulk weight scale), rather than just one measurement per animal if they had been weighed individually, with the error contribution remaining constant for each reading.

In some embodiments, the weighing device would be incorporated into the perches on which chickens sit. As will be seen later, analysis has shown that the number of perches is preferably 8 or more. If this is the case, then the ideal space on the perches would be for around 4 chickens.

Naturally, the greater the number of chickens accommodated on each perch, the smaller the amount of information known and so the greater the number of perches that must be provided with weighing devices to obtain measurements with an acceptable level of uncertainty. For example, 14 perches could be useful with space for up to 8 chickens on each perch.

The analysis made with respect to chickens and perches can equally be applied to other populations. For example, it may be determined that it is more efficient to have a number of weighing devices for a particular sheep or cattle population. For example, there could be provided parallel races with weigh scales over which the herds are encouraged to travel.

Further possible inputs into the system to provide greater accuracy in terms of a result include the likely minima and maxima based on such factors as the item or animal being weighed, its spread across the weigh scale, number of feet, likely weight range, likely population size, width and depth of platform and other application specific criteria.

It should be appreciated that the reference to reading animals and a time is expected to be in the order of say milliseconds with rapid weight measurements. Serial correlation data should be obtained that would give more information than just the sequence of weights.

Care also needs to be taken to ensure that with a moving population (as opposed to an intermittent perching population) the ingress and egress to the weighing device is as clear as possible to allow efficient flow of animals over the weighing device. Further, the ingress and egress needs to be sufficiently controlled to ensure that sufficient animals can be weighed to form a statistically significant sized random sample of the population.

Thus, in preferred embodiments of the present invention it is envisaged that the weighing device for animal herds would be a flat platform with open ends which is positioned within a race, in a gateway between fields, or as part of a load-on or load-off ramp used in conjunction with bulk animal transport.

It is envisaged that a typical number of animals fitting onto a platform could be in the order of say 10 sheep or cattle. It is also envisaged that the typical rate of sheep over the platform could be likely to be in the order of 50 sheep per minute.

In some embodiments, inputs from the weighing device may correspond to the impact of multiple members on the device in terms of weight. In the present invention, it is envisaged that the inputs will be representative of an ensemble of items/animals, with each input being a snapshot in time of the dynamic load on the device made up of an unknown number (and part thereof) of items/animals at any point in time. The values derived from the inputs are likely to representative of an estimate of a population frequency distribution of the weights. From this estimate one can calculate quantities, e.g. the proportion of members of the population with weight greater than some specified weight.

A typical probability theory used with regard to the inputs is likely to have the form of a maximum likelihood estimator, that is, supposing there is a model that generates the input data values, the method will find the parameter values for that model that make the observed data most likely.

It is envisaged that the present invention could utilise some existing technology.

However specific differences enabling the present invention could include:
size of the weighing platform,
sampling rate,
time between each discrete data point read from the weigh scales,
time over which the weigh scale data is collated,
number (and likely maximum number) of animals on the weighing platform at any one time,
number of data points,
processing of data points to produce a distribution, and
the decision criteria applied to the population distribution.

The subsets derived in accordance with the present invention will vary according to the type of situation in which the present invention is being applied.

For example, the subset values associated with chickens sitting on a perch are likely to be a whole number.

However, with herd populations passing over a weigh scale it is likely that the subsets could represent say quarters of animals corresponding to approximately to the impact of 1, 2, 3 or 4 feet of the animal onto the weigh scale.

The means by which the subsets are determined can be achieved by a variety of statistical calculations. These can include probability theory (expectation-maximisation), data cluster analysis and probability density distribution.

It can be seen that the present invention offers a number of advantages over the prior art. With minimal technical development, it is possible to provide a system whereby significant economic decisions can be made with respect to bulk populations.

This can be done in a way which takes minimal time compared to the individual processing of animals such as that done in the dairying case.

The nature of the present invention is that it could be adapted to existing physical configurations already on farms, such as existing races, with merely the placement of a weighing device in the appropriate position.

### BRIEF DESCRIPTION OF DRAWINGS

Further aspects of the present invention will become apparent from the following description which is given by way of example only and with reference to the accompanying drawings in which:

FIGS. 1 to 13 represent various statistical plots with respect to use of the present invention with chickens, and

FIGS. 14 to 17 represent various statistical plots with respect to use of the present invention with sheep.

### BEST MODES FOR CARRYING OUT THE INVENTION

Below is a discussion as to how to determine an ideal number of perches and perch sizes when the present invention is applied to determine the weight frequency distribution of a simulated chicken population.

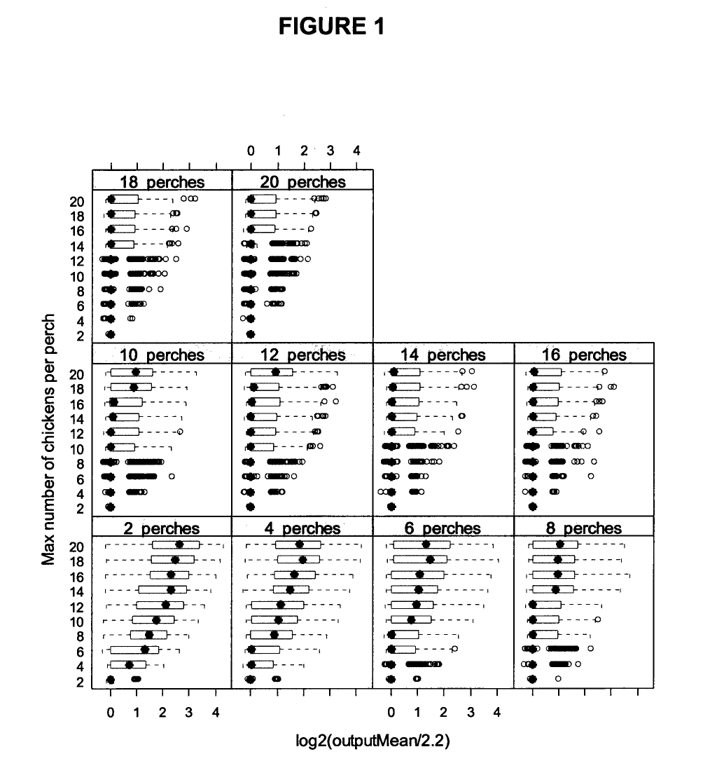

FIG. 1 is a “box and whiskers” plot. This was achieved by plotting the base-2 logarithm of the estimated mean chicken weight for each case divided by 2.2 kg (which is the actual mean chicken weight). Therefore, on this graph, a correct estimate of the mean weight for the chickens would give an x-value of zero. The dot in the centre of each box is the median of the data. The box, if shown, extends between the lower quartile and the upper quartile (i.e. the box contains half of the data) and the “whiskers” extend to the nearest value above or below the box that is no more than 1.5 times the width of the box. Any data outside the extent of the whiskers are shown as circles. Thus, a good outcome is to have box and the whiskers so narrow that they cannot be seen under the median dot.

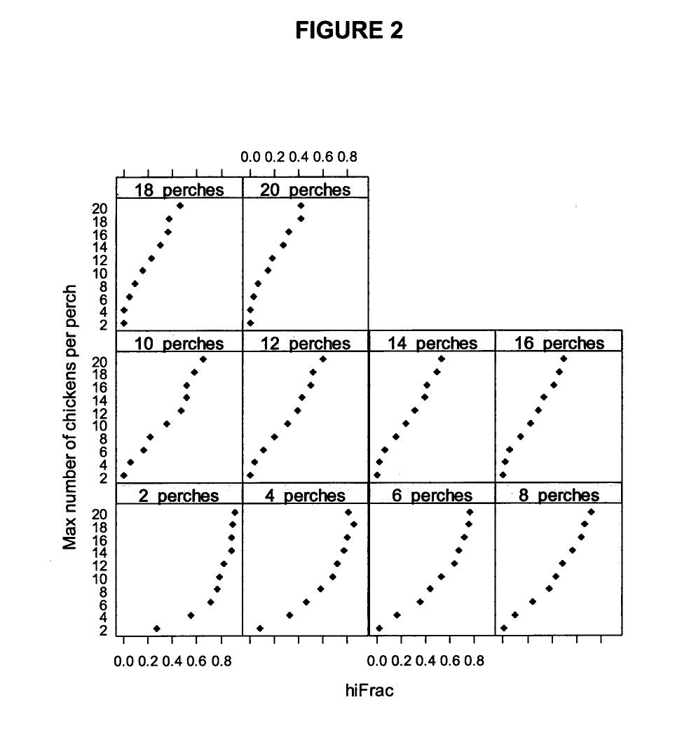

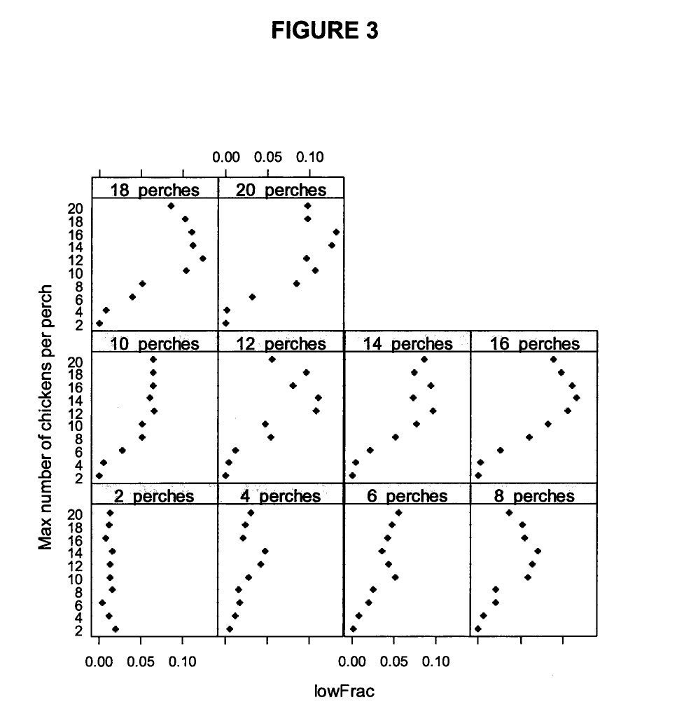

The fractions of the estimated mean weight values that were more than 5% above or below the actual mean weight of the chickens are illustrated in FIGS. 2 and 3 respectively for many simulated combinations of a number of perches, each capable of supporting a given maximum number of chickens per perch.

It should be noted that all computer code shown is for use with the statistical software “R” (R Development Core Team (2008). R: A language and environment for statistical computing. R Foundation for Statistical Computing, Vienna, Austria. ISBN 3-900051-07-0, URL http://www.R-project.org).

With chickens it is expected to measure the weight of each perch perhaps every 5 minutes. The erroneous estimates of the mean weight can be readily distinguished from the bulk that are within 5% of the actual mean weight value and a software implementation may simply discard those erroneous measurements in calculating the weight trend. To successfully identify and discard the erroneous measurements, they should not make up more than around 20% of the total, considering the low and high error fractions together. These graphs suggest that to gain satisfactory precision, we would therefore need (for example):
At least 6 occupied perches if there were up to 4 birds per perch, or
At least 10 occupied perches if there were up to 6 birds per perch, or
At least 14 occupied perches if there were up to 8 birds per perch, or
At least 18 occupied perches if there were up to 10 birds per perch.

A discussion of an approach which can be applied to herd animals in accordance with the present invention is given below.

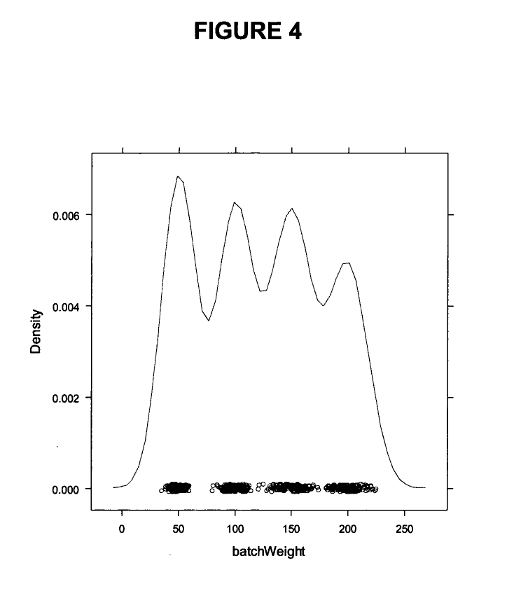

FIG. 4 illustrates batch weight density plot for 1000 simulated animals in 500 batches of up to 4 animals, with a mean animal weight of 50 kg and a standard deviation of 5 kg:

FIG. 4 clearly identifies that there are four peaks which correspond to subsets of whole animals.

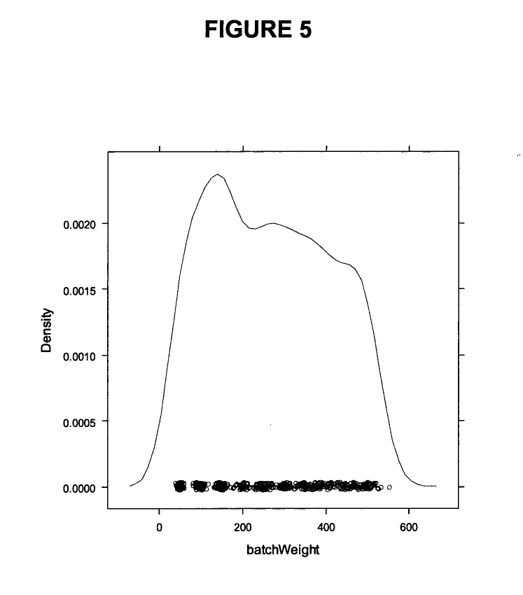

The same calculation for batches of up to 10 animals is illustrated in FIG. 5. Unfortunately, FIG. 5 illustrates that having a higher number of animals in a batch does not give clear subsets as desired by the present invention.

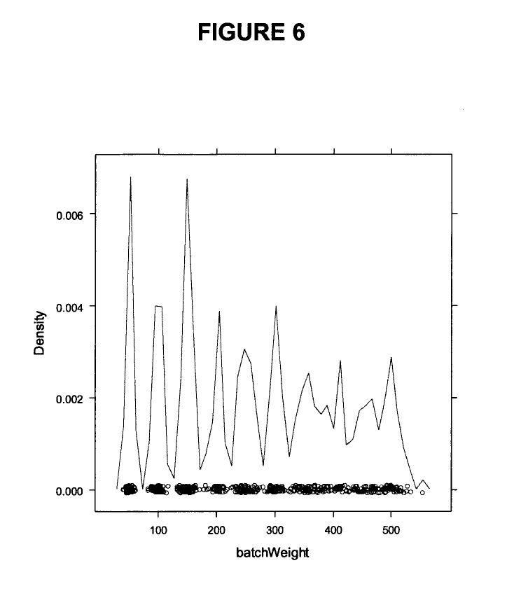

Thus, by making the band width of the smoothing kernel smaller, a more useful graph is obtained (see FIG. 6). This is achieved by using “adjust=0.1” in the densityplot( ) function of the R software.

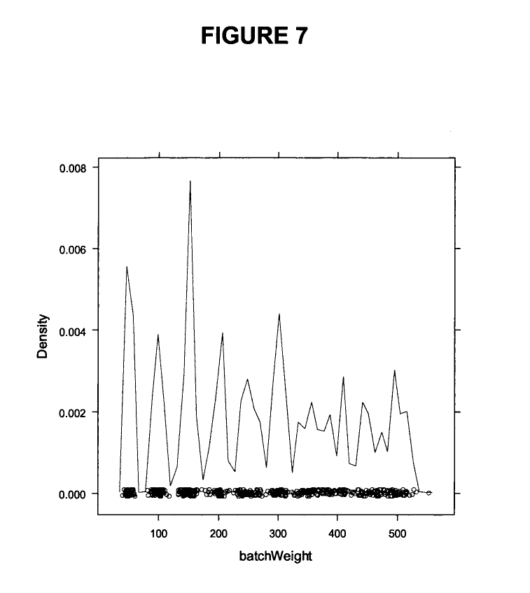

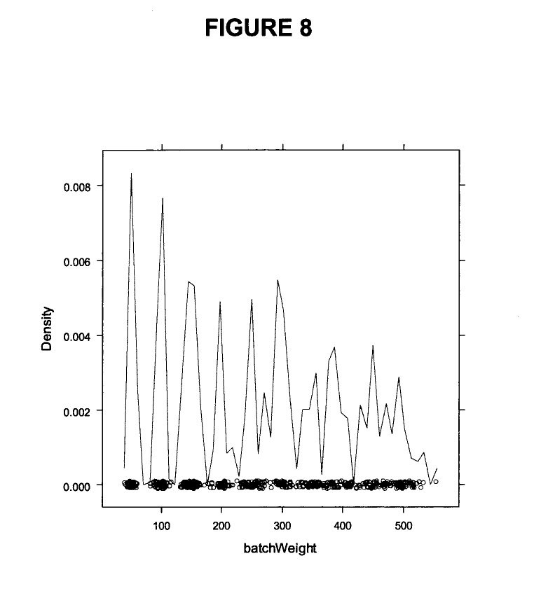

Changing the “adjust” to 0.5 also provides relatively clear subsets as shown in FIG. 7. Likewise, using “adjust=0.01” is shown in FIG. 8.

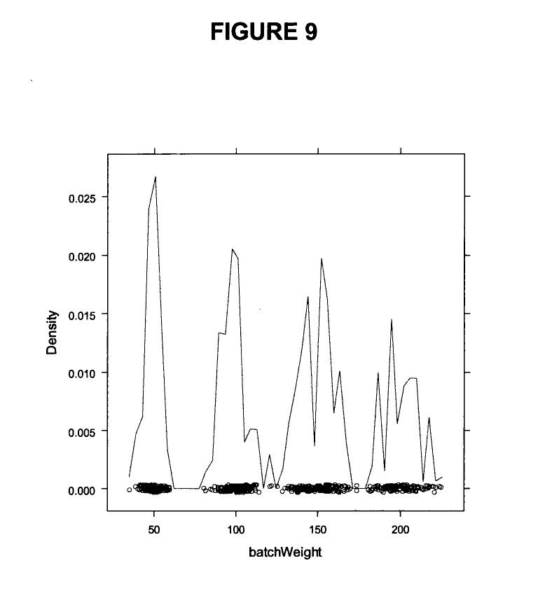

FIG. 9 illustrates for batches up to four animals a density plot with “adjust=0.01”.

Thus, the batches with different numbers of animals can be distinguished using the density plot as well as by using an Expectation Maximisation algorithm described by Dempster et al (Dempster, A. P.; Laird, N. M.; Rubin, D. B. (1977). “Maximum Likelihood from Incomplete Data via the EM Algorithm”. Journal of the Royal Statistical Society. Series B (Methodological) 39 (1): 1-38. JSTOR 2984875. MR0501537). Batches with different numbers of animals could also be distinguished with cluster analysis. To determine this, a cluster analysis was run on the weights of batches of up to 10 animals using:

plclust(hclust(dist(batchWeights10$batchWeight)),labels=FALSE)

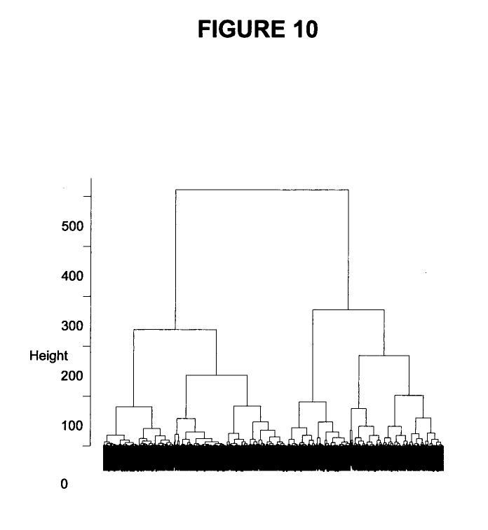

This result is illustrated in FIG. 10.

Again all computer code shown is for use with the statistical software “R” (R Development Core Team (2008). R: A language and environment for statistical computing. R Foundation for Statistical Computing, Vienna, Austria. ISBN 3-900051-07-0, URL http://www.R-project.org).

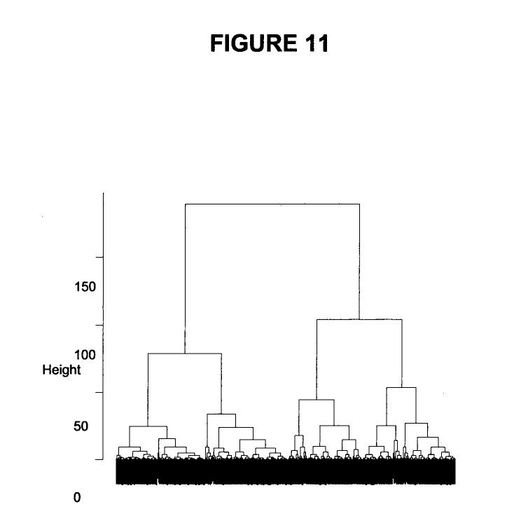

The same analysis was conducted on batches up to four animals and the result of this is illustrated in FIG. 11.

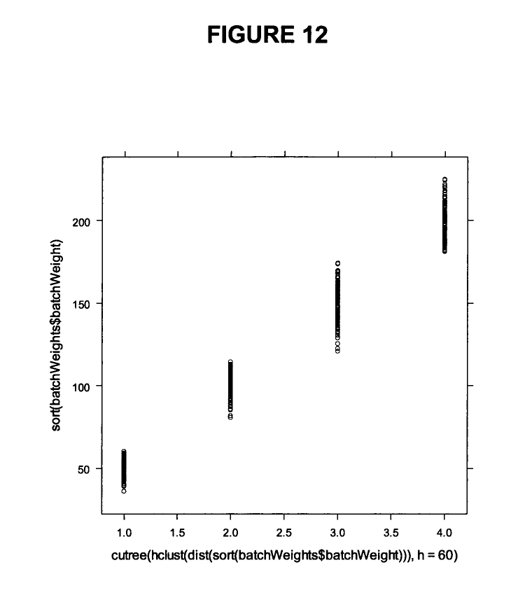

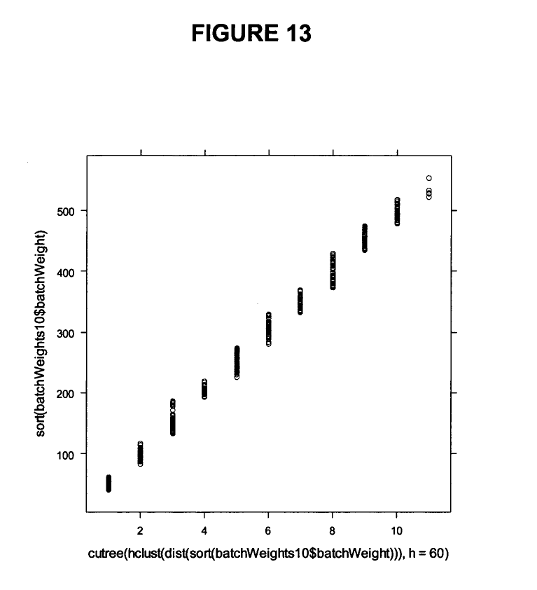

Plotting the clusters for batches up to four are shown in FIG. 12 and for batches up to 10 are shown in FIG. 13.

Thus, a clustering algorithm can be used to find the medians of the clusters and the numbers of the clusters.

Likewise, it is considered that density plots could also be used to find the individual peak values for each batch.

The following is description of the present invention applied to a mob of approximately 280 sheep.

Firstly, individual weights of the sheep were recorded.

Then the entire mob was statically weighted in groups of 1 to 7 animals on a weigh scale, with the weigh scale recording only the total weight of the animals on the scale at any one time.

Next, the entire mob was moved over the scale as continuously as possible. Raw data of the animal weights were recorded at a rate of approximately 55 samples per second. Each of these last two steps was undertaken twice.

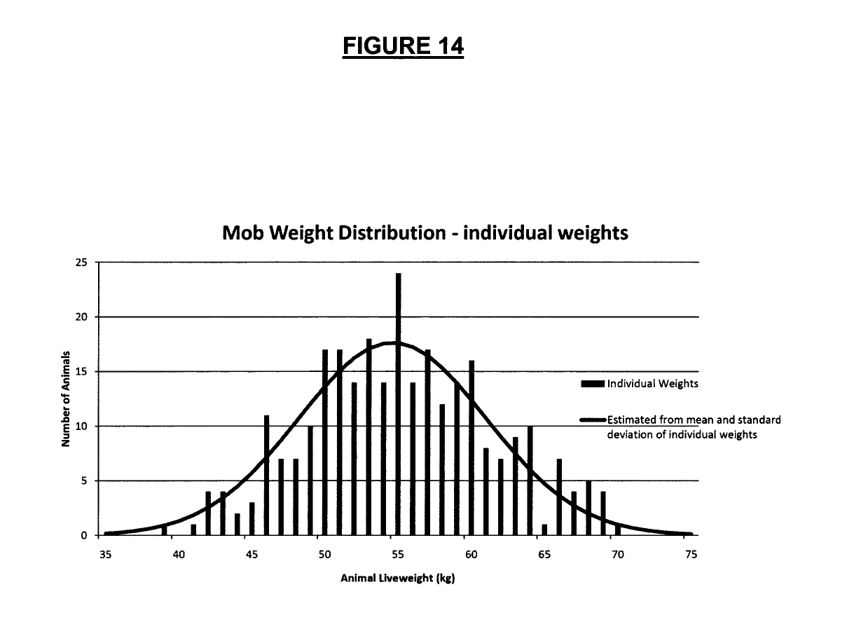

FIG. 14 illustrates the mob weight distribution, based on individual animal weights of the mob.

The following observations can be made:

The estimated distribution from the mean and standard deviation of individual weights provides an approximate normal curve that matches the actual individual weights.

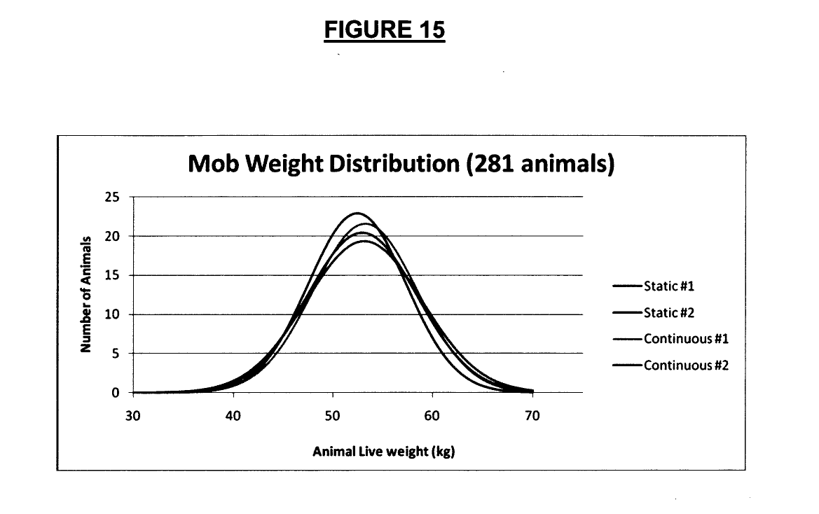

The invention produced estimated means and standard deviations that were highly consistent in all four trials, as illustrated in FIG. 15.

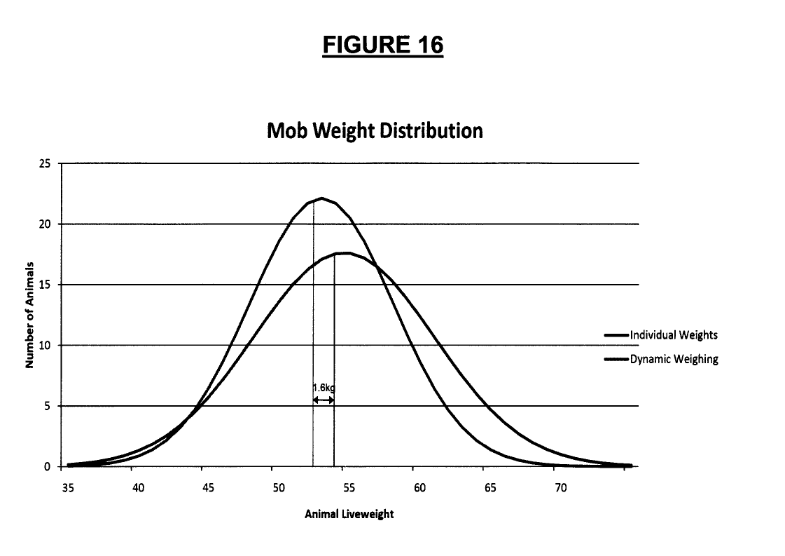

An initial analysis using dynamic weighing is shown in FIG. 16 and it can be seen that there is a bias of 1.6 kg between the mean calculated from dynamic weighing and that calculated from static weighting. This is attributed to the fact that different load cells were used to weight the animals individually from those used for the dynamic weighing trials. The means and standard deviations are considered satisfactorily similar for the purposes of demonstrating the efficacy of dynamic weighing given known error contributions.

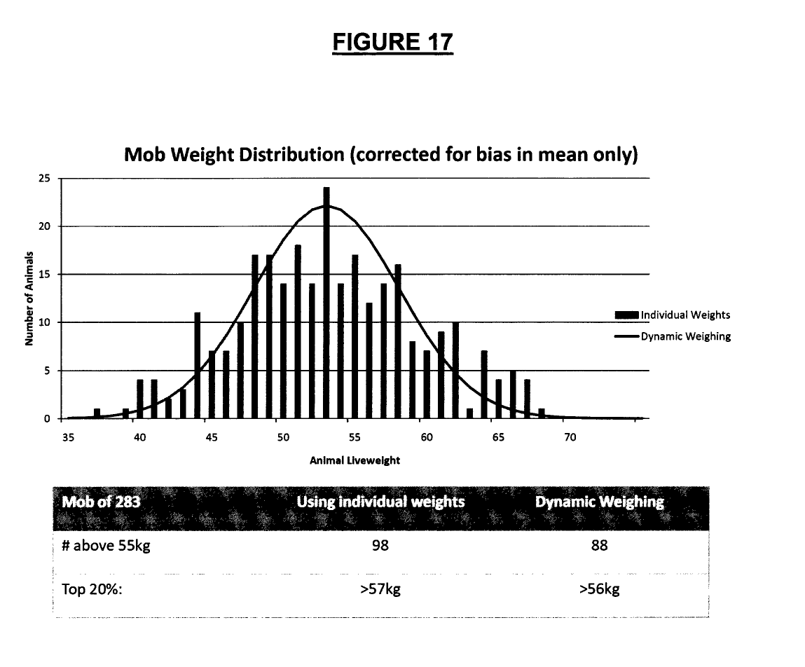

It can be seen that the population data matches the individual weights data closely in FIG. 17 when this constant bias in the mean has been allowed for.

In summary, the present method when applied to real sheep generated highly consistent results in four separate data sets drawn from the same mob. This correlated well with individual weight data.

Segmentation based on a percentage of mob above/below specific weight was accurate to approximately 1 kilogram.

Segmentation based on classification to a specific weight was accurate to approximately 4 percent.

These results are highly promising and illustrate the ability of the present invention to provide accurate population measurements using dynamic weighing.

Aspects of the present invention have been described by way of example only and it should be appreciated that modifications and additions may be made thereto without departing from the scope of the appended claims.

1. A method of determining the weight distribution of a population
the method comprising:
a) determining a likely weight range for members within the population;
b) enabling a plurality of members of the population to impact on a weighing device wherein multiple members may be on the weighing device at one time;
c) recording inputs from the weighing device wherein each input corresponds to the presence of the multiple members on the weighing device at one time; and
d) using values derived from the inputs and applying an algorithm to specify a number of subsets, each of the subsets representing a discrete number or proportion of members with weight values associated with same.

2. A method as claimed in claim 1 wherein the subsets are used to determine a weight frequency distribution for the measured population.

3. A method as claimed in claim 1 wherein the population members are herd animals.

4. A method as claimed in claim 1 wherein typical weight ranges take into account population variance.

5. A method as claimed in claim 1 wherein individual animal weights are assessed through the control of the animals onto and off the weighing device.

6. A method of obtaining a value from a weighing device for use in the method claimed in claim 1,
further including the step of processing the inputs from the weighing device to provide an indicative value of sample size and weight.

7. A weighing device for use in the of claim 1,
the weighing device including
a platform of sufficient size to receive a plurality of members of a population to be weighed;
the platform having at least one ingress and egress for the members; and
a weight sensor for receiving inputs from members of the population positioned on the platform; and
a processor programmed to process inputs into a value suitable for the current calculation of in the weight distribution population.

8. A weighing system having at least one weighing device as claimed in claim 7, and
an animal guidance system.

9. A weighing system as claimed in claim 8 which includes a control mechanism for controlling the ingress and egress of the animals from the weighing device.

10. A weighing system as claimed in claim 8 which includes multiple weighing devices and guidance systems.

11. A computer program configured to be executable by a process to perform a method for determining the weight distribution of a population as claimed in claim 1.

12. (canceled)

13. (canceled)

14. (canceled)

15. (canceled)
